(19) United States
(12) Patent Application Publication
(10) Pub. No.: US 2007/0055573 A1
(43) Pub. Date: Mar. 8, 2007

(54) System and method for nutritional information feedback at the point of sale

(76) Inventor: Mathew L. Grell, Norcross, GA (US)

Correspondence Address: Mathew L. Grell, 4307 Jones Bridge Circle, Norcross, GA, 30092, US

(21) Appl. No.: 11/216,365

(22) Filed: Aug. 31, 2005

(51) Int. Cl. G06Q 30/00

(52) U.S. Cl. 705/24

(57) ABSTRACT

A computer program, method, system and/or apparatus for providing a purchaser, at the point of sale, the nutritional information of the food item(s) the purchaser has selected for purchase. The nutritional feedback method operational at a point of sale, the nutritional feedback method comprising identifying a food item selected for purchase and communicating the nutritional information of said selected food item to the purchaser.

### TECHNICAL FIELD

The present version of the invention relates generally to a computer program, method, system and/or apparatus for providing nutritional information of food item(s) at the time of purchase, and more specifically to dynamically and/or interactively provide a purchaser with nutritional information of the food items selected for purchase, generate suggested food item(s) with improved nutritional information, update the nutritional information of the suggested food item(s), calculate, display, and/or record the nutritional information of the food items selected, suggested and/or purchased.

### BACKGROUND OF THE INVENTION

Currently, the decision to purchase food or other consumables, whether at a fast food or standard restaurant, service provider, vending machine, convenient store, grocery store, supermarket, or other establishment that sells food and drink items (the “seller”), the purchaser of the food item has little to moderate nutritional information available to him or her when making a food purchase decision. For example, fast food restaurants may offer purchasers a brochure or flyer that has the nutritional break down of the individual food item available for purchase, a restaurant or other food service provider may offer similar information in a menu. Vending machines, convenient stores and grocery stores offer food items with nutritional fact labels on food packaging to assist the purchaser in their decision. These items provide the purchaser of food with table or text format information covering nutritional and ingredient facts regarding the individual food item. Such nutritional information is often difficult to understand, misleading, or assembled in non-standard format making it difficult to interpret.

In addition, estimating the nutritional content of individual types of food can be time consuming and laborious. Generally, the nutritional components (calories, fat, protein, carbohydrates) of each food item must be obtained from a table, which lists the nutritional components. The nutritional components for all the food items must be manually recorded, and summed to determine the nutritional information of the food item(s) selected for purchase. Typically, the individual effort required to calculate the nutritional information of the food items is great enough to discourage the individual from completing the calculation.

In addition, the seller of the food item(s) is unable to communicate the nutritional information of selected food item(s) to the purchaser at the point of sale, to suggest alternative food item(s) to the purchaser based on nutritional information of the selected food item(s), communicate the nutritional information of the selected and/or alternative food item(s) to purchaser, allow the purchaser to amend their food item(s) selection based on such nutritional information.

Therefore, for the above mentioned reasons, it is readily apparent that there is a need for a computer program, method, system, and/or apparatus that can provide a purchaser of food with the nutritional information of the purchaser's entire food purchase at the time of purchase, nutritional information of food items selected, suggest alternative food item(s) based on nutritional information of such food item(s).

### BRIEF SUMMARY

Briefly described, in a preferred embodiment, the present invention overcomes the above-mentioned disadvantage, and meets the recognized need for such a computer program, method, system, and/or apparatus that can provide the purchaser of food with the nutritional information of the entire food items selected at the point of sale or purchase.

According to its major aspects and broadly stated, the present invention in its preferred form is a computer program, method, system, and/or apparatus for identifying, analyzing, calculating, communicating, proposing alternative and/or displaying the nutritional information of food item(s) of selected and alternatively proposed food item(s) for purchase by a purchaser. A purchaser of food item(s) who is provided with the nutritional information of the purchaser's food item(s) at the point of sale has the necessary nutritional information to make healthier food purchase decisions regarding individual, entire meals and/or whole grocery store visit purchases.

Accordingly, a feature and advantage of the present invention is its ability to identify food item(s) selected for purchase at the point of sale.

Accordingly, a feature and advantage of the present invention is its ability to store as a record the nutritional information of a food item(s).

Accordingly, a feature and advantage of the present invention is its ability to summarize the nutritional information of a purchaser's food item(s) selected for purchase.

Accordingly, a feature and advantage of the present invention is its ability to communicate the nutritional information of food item(s) in text, table, graphical, icon, symbol or other display form.

Accordingly, a feature and advantage of the present invention is its ability to suggest or identify alternative food item(s) that are available for purchaser.

Accordingly, a feature and advantage of the present invention is its ability to communicate the nutritional information of the alternative food item(s) in text, table, graphical, icon, symbol or other display form.

Still another feature and advantage of the present invention is its ability to provide the purchaser with the ability to amend their food item(s) selection based on the alternative food item(s) and/or the nutritional information.

Yet another feature and advantage of the present invention is its ability to track/store the identity of the initial food item(s) selected for purchase.

Yet another feature and advantage of the present invention is its ability to track/store the identity of the alternative food item(s) proposed to purchaser and/or such food item(s) nutritional information.

Yet another feature and advantage of the present invention is its ability to track/store whether or not the purchaser elected to amend their food item(s) selection based on the suggested alternative food item(s) and/or their nutritional information.

Yet another feature and advantage of the present invention is its ability to track/store unknown purcahser(s) decisions of whether or not the unknown purchaser elected to amend their food item(s) selected based on the suggested alternative food item(s) and/or the nutritional information of the alternative food item(s).

Yet another feature and advantage of the present invention is its ability to track/store the identity of the final food item(s) selected for purchase and/or the nutritional information of the final food item(s).

Yet another feature and advantage of the present invention is its ability to track/store the purchaser's food item(s) purchase history and/or profile.

Yet another feature and advantage of the present invention is its ability to track/store the purchaser's food item(s) purchase history and/or profile over time.

Yet another feature and advantage of the present invention is its ability to track/store the purchaser's food item(s) nutritional information.

Yet another feature and advantage of the present invention is its ability to track/store the purchaser's food item(s) nutritional information over time.

These and other features and advantages of the present version of the invention will become more apparent to one skilled in the art from the following description and claims when read in light of the accompanying drawings.

### BRIEF DESCRIPTION OF THE DRAWINGS

The present version of the invention will be better understood by reading the Detailed Description of the Preferred and Alternate Embodiments with reference to the accompanying drawing figures, in which like reference numerals denote similar structure and refer to like elements throughout, and in which:

FIG. 1 is a block diagram of a computer system.

FIG. 2 is a block diagram of a communications system implemented by the system in FIG. 1.

FIG. 3 is a flow diagram of a communication method, according to the preferred embodiment of the present version of the invention, implemented by the system in FIG. 2.

FIG. 4 is screen shot of a user interface of the method of FIG. 3.

FIG. 5 is a flow diagram of a communication method, according to the preferred embodiment of the present version of the invention, implemented by the system in FIG. 2.

FIG. 6 is a screen shot of a user interface of the method of FIG. 5.

FIG. 7 is a screen shot of a user interface of the method of FIG. 5.

FIG. 8 is a screen shot of a user interface of the method of FIG. 5.

FIG. 9 is a screen shot of a user interface of the method of FIG. 5.

FIG. 10 is a screen shot of a user interface of the method of FIG. 5.

FIG. 11 is a screen shot of a user interface of the method of FIG. 5.

### DETAILED DESCRIPTION OF THE PREFERRED AND ALTERNATIVE EMBODIMENTS

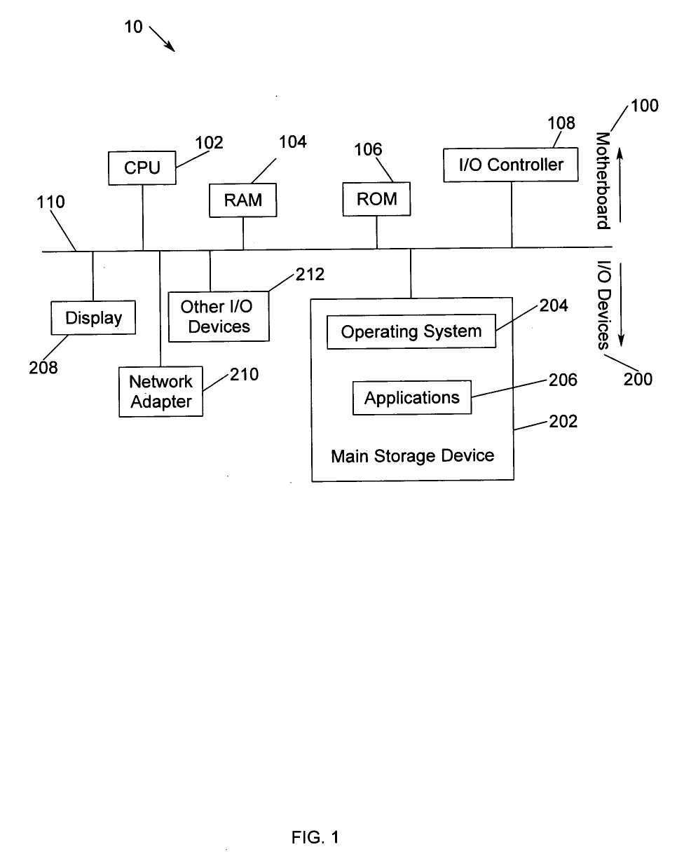

In describing the preferred and alternate embodiments of the present version of the invention, as illustrated in FIGS. 1-11, specific terminology is employed for the sake of clarity. The present version of the invention, however, is not intended to be limited to the specific terminology so selected, and it is to be understood that each specific element includes all technical equivalents that operate in a similar manner to accomplish similar functions.

As will be appreciated by one of skill in the art, the present version of the invention may be embodied as a method, data processing system, or computer program product. Accordingly, the present version of the invention may take the form of an entirely hardware embodiment, entirely software embodiment or an embodiment combining software and hardware aspects. Furthermore, the present version of the invention may take the form of a computer program product on a computer-readable storage medium having computer-readable program code embodied in the medium. Any suitable computer readable medium may be utilized including hard disks, ROM, RAM, CD-ROMs, electrical, optical or magnetic storage devices.

The present version of the invention is described below with reference to flowchart illustrations of methods, apparatus (systems) and computer program products according to embodiments of the present version of the invention. It will be understood that each block or step of the flowchart illustrations, and combinations of blocks or steps in the flowchart illustrations, can be implemented by computer program instructions. These computer program instructions may be loaded onto a general purpose computer, special purpose computer, or other programmable data processing apparatus to produce a machine, such that the instructions, which execute on the computer or other programmable data processing apparatus creating a method for implementing the functions specified in the flowchart block or blocks/step or steps.

These computer program instructions may also be stored in a computer-usable memory that can direct a computer or other programmable data processing apparatus to function in a particular manner, such that the instructions stored in the computer-usable memory produce an article of manufacture including instruction means which implement the function specified in the flowchart block or blocks/step or steps. The computer program instructions may also be loaded onto a computer or other programmable data processing apparatus to cause a series of operational steps to be performed on the computer or other programmable apparatus to produce a computer implemented process such that the instructions which execute on the computer or other programmable apparatus provide steps for implementing the functions specified in the flowchart block or blocks/step or steps.

Accordingly, blocks or steps of the flowchart illustrations support combinations of means for performing the specified functions, combinations of steps for performing the specified functions and program instruction means for performing the specified functions. It will also be understood that each block or step of the flowchart illustrations, and combinations of blocks or steps in the flowchart illustrations, can be implemented by special purpose hardware-based computer systems, which perform the specified functions or steps, or combinations of special purpose hardware and computer instructions.

Computer program for implementing the present version of the invention may be written in various object-oriented programming languages, such as conventional C calling. However, it is understood that other source or object oriented programming languages, and other conventional programming languages could be utilized without departing from the spirit and intent of the present version of the invention.

Referring now to FIG. 1-11, the present version of the invention in its preferred embodiment is a method, system and/or apparatus for identifying food items selected for purchase and communicating the nutritional information of the food item. More specifically, a method for creating, identifying, communicating, selecting, transmitting, storing, viewing, suggesting alternative(s) food item(s) and their nutritional information to a purchaser at the point of offer and/or sell of such food item(s) is set forth herein. For brevity, several elements in the figures described below are represented as monolithic entities. However, as would be understood by one skilled in the art, these elements each may include numerous interconnected computers and/or components designed to perform a set of specified operations and/or dedicated to a particular geographical region.

Referring now to FIG. 1, there is illustrated a block diagram of a computer system 10 that provides a suitable environment for implementing embodiments of the present version of the invention. The computer architecture shown in FIG. 1 is divided into two parts the motherboard 100 and the input/output (I/O) devices 200 connected to motherboard 100. The motherboard 100 includes a bus 110 which interconnects major subsystems such as a central processor (CPU) 102, a random access memory (RAM) 104, an input/output (I/O) controller 108, and read-only memory (ROM) 106, also known as firmware. A basic input output system (BIOS) containing the basic routines that help to transfer information between elements within the computer is stored in the ROM 106 or operably disposed in RAM 104. The computer further includes I/O devices such as a main storage device 202 for storing an operating system 204 and application programs 206 and a display 208 for visual output and/or input of data or information, respectively. The main storage device 202 is connected to the CPU 102 through bus 110, and communication between these devices is handled by a main storage controller (represented by ‘I/O controller 108’).

In particular, each CPU 102 is a general-purpose processor, that during normal operation, processes data under the control of operating system 204 and application software 206 stored in RAM 104 and ROM 106. The operating system 204 preferably provides a graphical user interface (GUI) 208 to the user. Application software 206 contains instructions that when executed on CPU 102 carryout the operations depicted in the flowcharts set forth herein.

Other I/O Devices

CPU 102 is coupled via bus 110 and peripheral component interconnect (PCI) host-bridge to PCI local bus (represented by ‘other I/O devices 210’). PCI host-bridge provides a low latency path through which CPU 102 may directly access PCI devices mapped anywhere within bus memory and/or I/O address spaces. PCI host-bridge also provides a high bandwidth path for allowing PCI devices to directly access RAM 104.

PCI local bus interconnects a number of devices for communication under the control of PCI controller local (represented by ‘I/O controller 108’). These devices include a small computer system interface (SCSI) controller, which provides an interface to SCSI hard disk, and communications adapter(s), which interface computer system 10 to at least one data communication network over network adapter comprising wired and/or wireless network communications. The network adapter allows the computer system to send and receive data through communication devices. One example of a communications device is a modem. Other examples include a transceiver, a set-top box, a communication card, a satellite dish, an antenna, or another network adapter capable of transmitting and receiving data over a communications link that is either a wired, optical, or wireless data pathway. A graphics adapter is also attached to PCI local bus for controlling visual output to a display. In alternate embodiments of the present invention, additional peripheral components may be added. For example, in alternate embodiments, an interactive display screen component may be provided.

PCI local bus is further coupled to an industry standard architecture (ISA) bus by an expansion bus bridge (represented by ‘other I/O devices 210’). ISA bus has an attached I/O (Input/Output) controller (represented by ‘I/O controller 108’) that interfaces computer system 10 to peripheral input devices such as a keyboard and mouse (not illustrated) and supports external communication via parallel, serial and universal serial bus (USB) ports, respectively.

Many other devices or subsystems (represented by ‘other I/O devices 210’) may be connected in a similar manner such as without limitation a keyboard, a pointing device (e.g., a mouse), floppy disk drive operative to receive a floppy disk, CD-ROM player operative to receive a CD-ROM, personal storage device, such as smart card, static memory or other portable storage device that stores data for a particular user or users and is easily transportable, printer, modem each connected via an I/O adapter, wireless receiver and/or transmitter operative to receive and/or transmit data or information to and/or from a remote location, a card reader operative to read a user identification card and/or a credit card, a user identification device such as a signature pad, and a transaction device for receiving and distributing money, tokens and/or coupons.

Examples of such systems include but are not limited to point of sale systems, kiosks, desktop computer, network computer, midrange computer, or mainframe computer. In addition, the computer system may also be a remote or portable computing system such as a laptop computer, a personal digital assistant, or cellular telephone, or other wireless device as well as a stand-alone system or part of a network. Point of sale shall mean the store, dealer, machine, system, cashier's desk, check-out counter, point-of-purchase or other outlet where a food item(s) is sold or close in time to such transaction.

Also, it is not necessary for all of the devices shown in FIG. 1 to be present to practice the present version of the invention, as discussed below. Furthermore, the devices and subsystems may be interconnected in different ways from that shown in FIG. 1. The operation of a computer system such as that shown in FIG. 1 is readily known in the art and is not discussed in detail in this application, so as not to overcomplicate the present discussion.

Therefore, in general, the present invention is preferably executed on a computer system that performs computing tasks such as manipulating data from a storage device that is accessible to the computer system.

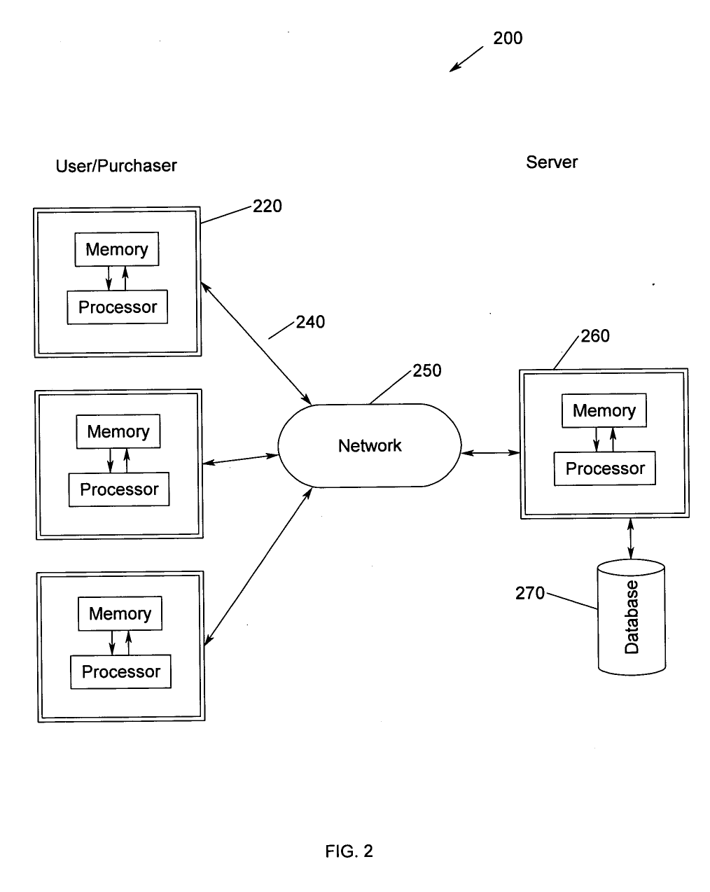

Referring now to FIG. 2, there is illustrated a diagram depicting an exemplary system in which concepts consistent with the present version of the invention may be implemented. Examples of each element within the communication system of FIG. 2 are broadly described above with respect to FIG. 1. In particular, the server system 260 and purchaser system 220 have attributes similar to computer system 10 of FIG. 1 and illustrates one possible implementation of that system. The communication system 200 includes one or more purchaser system 220, and one or more server device 260, and a network 250, which could be, for example, the local area network (LAN). Purchaser systems 220 each include a computer-readable medium, such as random access memory, coupled to a processor. The processor executes program instructions stored in memory. Purchaser system 220 may also include a number of additional external or internal devices, such as, without limitation, interactive display screen, card reader, printer, signature pad, transaction device and other attributes similar to computer system 10 of FIG. 1. The communications system 200 typically includes one or more purchaser system 220. For example, the purchaser system 220 may include one or more general-purpose computers (e.g., personal computers), one or more special purpose computers (e.g., devices specifically programmed to communicate with each other and/or the server system 260), one or more interactive display screens, workstation, server, device, digital assistant or a “smart” cellular telephone or pager, component, other equipment, or some combination of these elements that is capable of responding to and executing instructions.

Similar to purchaser system 220, server system 260 includes a computer-readable medium, such as random access memory, coupled to a processor. The processor executes program instructions stored in memory. Server system 260 may also include a number of additional external or internal devices, such as, without limitation, a mouse, a CD-ROM, a keyboard, a display, interactive display screen, a storage device and other attributes similar to computer system 10 of FIG. 1. Server system 260 may additionally include a secondary storage element, such as database 270 for storage of data and information. Server system 260, although depicted as a single computer system, may be implemented as a network of computer processors. Memory in server system 260 contains application programs that perform specific functions. For example, the server system 260 may include one or more general-purpose computers (e.g., personal computers), one or more special purpose computers (e.g., devices specifically programmed to communicate with each other) a workstation or other equipment, or some combination of these elements that is capable of responding to and executing instructions. Database 270 preferably includes the nutritional information for each food item available for purchase by purchaser and offered for sale by seller.

Communications system 200 is capable of delivering and exchanging data between purchaser system 220 and a server system 260 through communication links 240 and/or network 250. Through purchaser system 220, users can communicate over communication links 240 and/or network 250 with each other and with other systems and devices coupled to communication links 240 and/or network 250, such as server system 260. The communications link 240 typically includes a delivery network 250 making a direct or indirect communication between the purchaser system 220 and the server system 260, irrespective of physical separation. Examples of a network 250 include the Internet, the World Wide Web, wide-area network (WAN), local-are network (LAN), analog or digital, wired and wireless telephone networks (e.g. PSTN, ISDN, or XDSL), radio, television, cable, twisted pair, fiber optic, satellite, and/or any other delivery mechanism for carrying and/or transmitting data or other information. Network 250 can be a communication bus within a single personal computer (PC), PC or server with remote interactive display screen. The communications link 240 may include, for example, a wired, wireless, circuit board, cable, optical or satellite communication system or pathway. In some communication systems 200 network 250 may be located in the same system such as a vending machine or personal computer point-of-sale system.

Application program 206 includes but is not limited to, alternative food item(s) suggestion program, which generates alternative food item(s) available for purchase to fulfill a deficient food group or improve dietary composition of the purchaser's food item(s) selected for purchase. Alternative food item(s) suggestion program is in communication with server 260. In general, processes for indexing records in a database and searching the indexed body of records to return a set of records matching the food item(s) or search query are well known in the art.

Food item(s) shall include but not be limited to snack, food or meal item or items, whether provided at a fast food, restaurant, food service provider, cafeteria, vending machine, convenient store, grocery store, service counter, or other edible material.

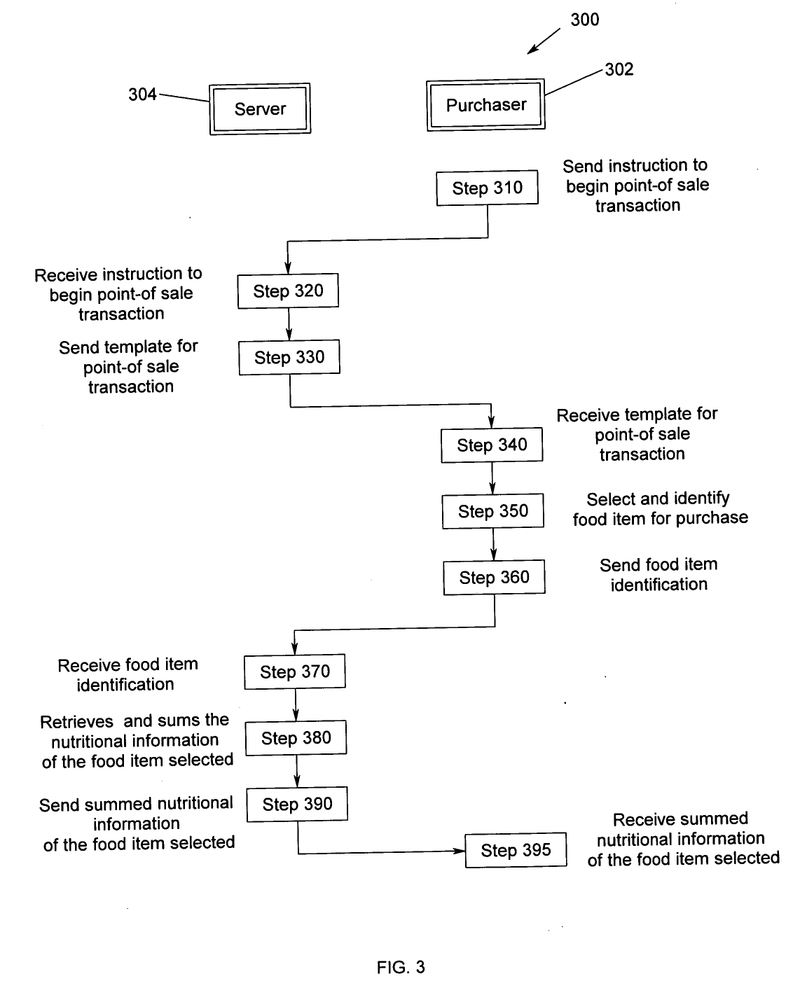

Referring now to FIG. 3, there is illustrated a preferred flow diagram in which purchaser 302 and server 304 interact according to a process 300 within the communication system 200 of FIG. 2. Purchaser 302 preferably has attributes comparable to those described above with respect to purchaser system 220. Purchaser is referred to hereafter as a purchaser or user of communication system 200 based on the methods described herein. Server 304 preferably has attributes comparable to those described above with respect to server system 260. Server 304 is preferably interconnected to purchaser 302 through a known or described delivery network. The network preferably has attributes comparable to those described above with respect to network 250. Process 300 preferably can be implemented by communication system 200 or other similar hardware, software, device, computer, computer system, equipment, component, application, code, storage medium or propagated signal.

As illustrated in FIG. 3, purchaser 302 preferably sends to server 304 an instruction to begin a point of sale transaction (step 310). Server 304 preferably receives the instruction that purchaser 302 has requested to begin a point of sale transaction (step 320). In response server 304 preferably sends purchaser 302 at least one template 400 to assist purchaser 302 with purchasing food item(s) (step 330). Purchaser 302 preferably receives at least one template 400 from server 304 (step 340). Template 400 preferably is a graphical user interface (GUI) to assist a purchaser 302 in selecting and/or identifying a food item(s) for purchase, initiating a process to identify a food item being purchased, or perform a point of sale transaction.

Purchaser 302 preferably selects a food item(s) for purchase and identifies the food item(s) by selecting the item(s) using template or by keying-in the identification code or any other identification apparatus, method, process or system (step 350). For example, identification of the food item(s) may be performed by scanning the food item(s) bar code, uniform product code (UPC), by radio frequency identification (RFID) or any other identification system and such identification can be performed by purchaser 302, server 304 or by both, or by an intermediate identification system.

Purchaser 302 preferably sends to server 304 the identity of the food item(s) selected for purchase (step 360). Server 304 preferably receives the identity of the food item(s) selected for purchase (step 370). Server 304 retrieves the nutritional information from database 270 corresponding to the food item(s) selected for purchase and sums the nutritional information of such food item(s) (step 380). In response server 304 preferably sends purchaser 302 the summed nutritional information of the food item(s) selected for purchase (step 390). Purchaser 302 preferably receives the summed nutritional information of the food item(s) selected for purchase (step 390).

Nutritional information records stored for each food item(s) can include but is not limited to allergens, calories, carbohydrates, cholesterol, energy, fat (monounsaturated, polyunsaturated, and saturated), fiber (soluble and insoluble), food group, ingredients, minerals, nutrient, processed foods, protein, raw foods, recommended daily allowances, serving size, sodium, sugar, supplement, vitamins, water, hydration, whole foods, and/or other nutritional components.

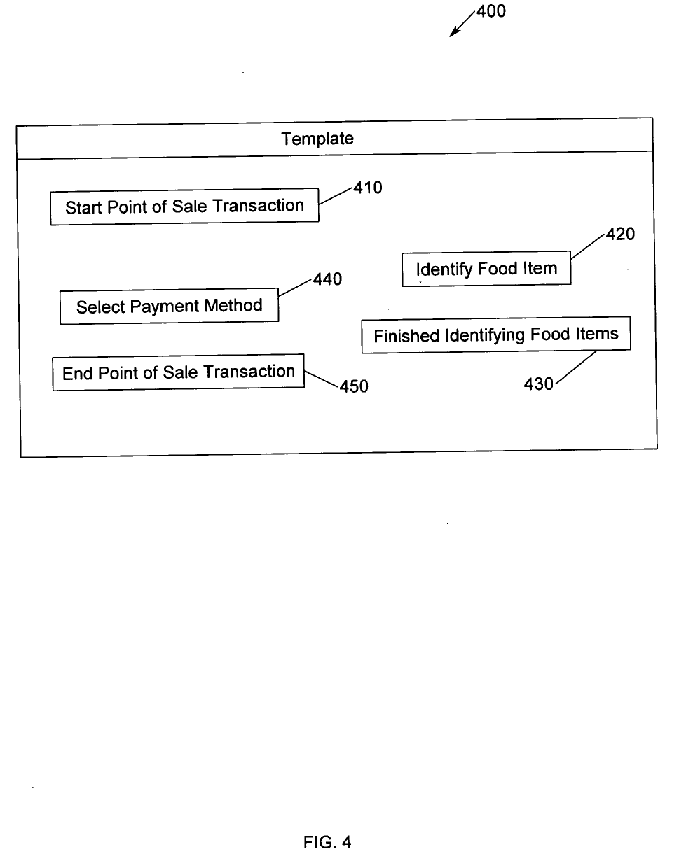

Referring now to FIG. 4, there is illustrated a preferred screen shot of a user interface disclosing a template to enter member information, including start point of sale transaction 410, identify food item 420, finished identifying food items 430, select payment method 440, and end point of sale transaction 450 or other such point of sale information as would meet the purpose described herein.

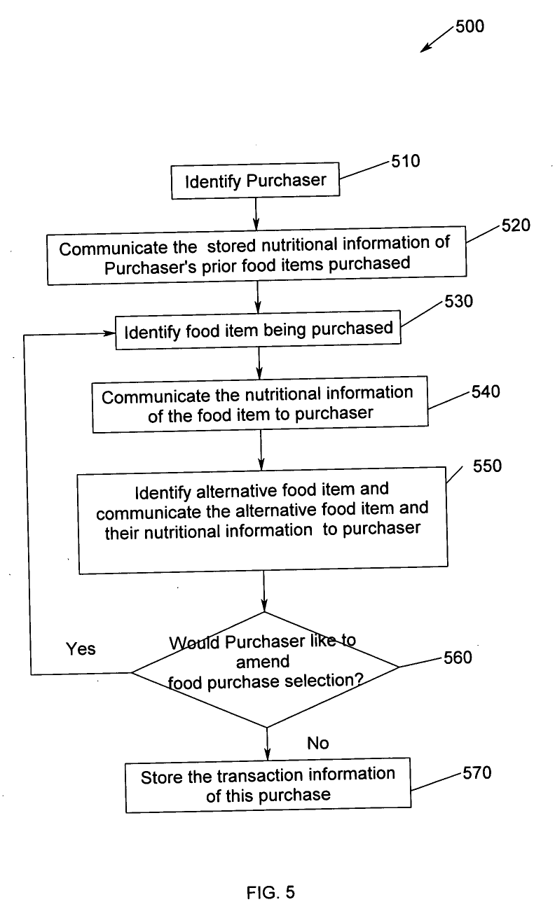

Referring now to FIG. 5, there is illustrated a preferred flow diagram in which purchaser 502 and server 504 interact according to a process 500 within the communication system 200 of FIG. 2. Purchaser 502 preferably has attributes comparable to those described above with respect to purchaser system 220. Server 504 preferably has attributes comparable to those described above with respect to server system 260. Server 504 is preferably interconnected to purchaser 502 through a known or described delivery network. The network preferably has attributes comparable to those described above with respect to network 250. Process 500 preferably can be implemented by communication system 200 or other similar hardware, software, device, computer, computer system, equipment, component, application, code, storage medium or propagated signal.

As illustrated in FIG. 5, a first step 510 of process 500 preferably includes identifying purchaser 502 at the point of sale or close in time to the point of sale. By way of example only and not by way of limitation, grocery stores and other food suppliers provide purchasers with identification cards wherein such cards can be scanned during the transaction to identify purchaser 502. Additional methods for identifying purchaser 502 such as the telephone number of purchaser 502 may be used to identify purchaser 502.

A second step 520 includes retrieving from database 270 the nutritional information of purchaser 502 prior food item(s) selected for purchase and communicating such information to purchaser 502 or a summary of such nutritional information or other such transactional information. If purchaser has no previous stored nutritional information then no information is communicated or a message such as “no information is on file” is communicated to purchaser 502. Generally, the nutritional information of purchaser 502 will include nutritional information on a plurality of food item(s).

Purchaser 502 selects from and switches between multiple types of display modes wherein server 504 communicates such information to purchaser 502. For example, purchaser 502 preferably selects a graphical display; however, purchaser 502 may select to view nutritional information as a chart, icon, spreadsheet, symbol, text, table, or other display mode.

A third step 530 includes identifying food item(s) being purchased by purchaser 502. For example, identification of the food item(s) is preferably performed by scanning the food item(s) bar code, however, other methods of identifying food item(s) such as by keying-in the food item(s) identification code or uniform product code (UPC), by radio frequency identification (RFID) or any other identification system wherein such identification can be performed by purchaser 502, server 504 or by both, or by an intermediate identification system.

A fourth step 540 includes communicating the nutritional information of the food item(s) identified at the point of sale or close in time to the point of sale transaction by retrieving the individual nutritional information for each food item from database 270 and communicating such information to purchaser 502. If purchaser 502 has selected more than one item for purchase then server 504 preferably sums the nutritional information for all identified food item(s) and communicates such information to purchaser 502. In addition, server 504 may communicate to purchaser 502 other information such as the nutritional information of prior food item(s) purchased by purchaser 502, the identified food item(s) of this transaction, and/or a summation of prior and/or identified nutritional information of said food item(s) separately, together or any combination thereof.

Nutritional information records stored for each food item(s) can include but is not limited to calories, carbohydrates, cholesterol, energy, fat (monounsaturated, polyunsaturated, and saturated), fiber (soluble and insoluble), food allergies, food group(s), ingredients, minerals, nutrient, processed foods, protein, raw foods, recommended daily allowances, serving size, sodium, sugar, supplement, vitamins, water, hydration, whole foods, and/or other nutritional information or components.

A fifth step 550 includes server 504 communicating alternative food item(s) and/or their nutritional information to purchaser 502, wherein said alternative food item(s) are available for purchase. Alternative food item(s) are determined by comparing the initial food item(s) identified for purchase by purchaser 502 and/or the prior food item(s) purchased by purchaser 502 to that of the recommended food item(s) and/or groups of food item(s) set forth in sources such as those published by the Federal government, medical, nutritional, exercise and/or dietary sources or other government and/or private sources for nutritional information. Thus, suggesting alternative food item(s) and/or groups of food item(s) at the point-of-sale or close in time to the point of sale transaction, wherein such alternative food item(s) fulfill a deficient food group or improves dietary composition of the purchaser's food item(s) selected for purchase by purchaser 502 during such transaction(s).

Server 504 preferably retrieves the alternate food item(s) and their nutritional information from database 270 wherein the nutritional information is linked to the identified food item(s). Server 504 preferably communicates the nutritional information of the alternative food item(s) to purchaser 502. In addition, server 504 may communicate to purchaser 502 other information such as the nutritional information of prior food item(s) purchased by purchaser 502, the identified food item(s) of this transaction, the alternative food item(s), and/or a summation of prior, identified and/or alternative nutritional information of such food item(s) separately, together or any combination thereof.

A sixth step 560 includes prompting, asking, and/or determining whether purchaser 502 would like to amend his or her food item(s) selected based on the alternative food item(s) proposed in step 550 and their nutritional information. If yes, purchaser 502 returns to step 530 where purchaser 502 identifies food item(s) to be purchased such as the alternative food item(s). Otherwise, if purchaser 502 has identified all the food item(s) to be purchased and does not want to amend the selected food item(s) then the seventh step 570 is executed. In step 570 the point of sale transaction is completed for the food item(s) selected for purchase. In addition, server 504 stores in database 270 the transaction information of purchaser 502 including but not limited to, the identity of purchaser 502, the identity of the food item(s) initially identified/selected, the identity of the alternative food item(s) proposed to purchaser 502, whether or not purchaser 502 decided to amended food item(s) initially identified for purchase, the identity of the final food item(s) purchased, such food item(s) nutritional information, food item(s) purchase history or profile of purchaser 502, food item(s) purchase history or profile over time of purchaser 502 and/or any other transactional information. Server 504 preferably communicates this transaction information to purchaser 502 by displaying such information on a terminal, printing such transaction information on a receipt provided to purchaser 502 at the end of the point-of-sale transaction, or by any other applicable communication method.

For example, if purchaser 502 entered a fast food restaurant and initially ordered a burger, fries and soft drink the nutritional information communicated by server 504 in step 540 to purchaser 502 preferably would include the information set forth in FIG. 6. The graphical display to the left in FIG. 6 represents the recommended nutritional information of a purchase and the graphical display to the right in FIG. 6 represents the nutritional information of the food item(s) selected for purchase by purchaser 502.

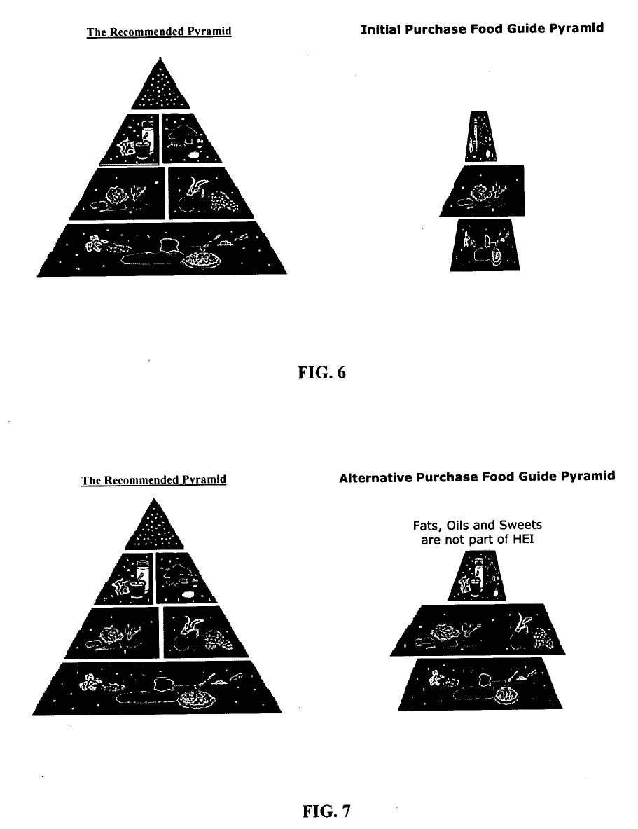

In step 550, server 504 preferably determines that the selected food item(s) are deficient in variety, grains, vegetables, fruits, and/or water and abundant in fat. Thus, server 504 preferably communicates alternative food item(s) in such deficient food groups, which are available for purchase, including but not limited to a garden salad, olive oil based lite-vinaigrette, soy burger, tomato slice, romaine lettuce, whole-wheat bun, apple, orange, milk, and/or water. In addition, server 504 communicates any other food item(s) that fulfill a deficient food group or improves the dietary composition of the purchaser's food item(s) selected for purchase. Such alternative food item(s) represent food item(s) having variety, grains, vegetables, fruits, water and/or healthy fat. The nutritional information communicated by server 504 to purchaser 502 preferably would look like the information set forth in FIG. 7. The graphical display to the left in FIG. 7 represents the recommended nutritional information of a purchase and the graphical display to the right in FIG. 7 represents the nutritional information of the alternative food items, garden salad, olive oil based lite-vinaigrette, soy burger, tomato slice, romaine lettuce, whole-wheat bun, orange, and milk, proposed by server 504.

In step 560, purchaser 502 would be prompted to amend their initial food item(s) selected for purchase.

For an alternative example, if purchaser 502 makes a vending machine selection to initially purchase one grab-size bag of chips and the nutritional information communicated by server 504 in step 540 to purchaser 502 preferably would include the information set forth in FIG. 8. The graphical display in FIG. 8 represents the nutritional information of the food item(s) selected for purchase by purchaser 502 (i.e., “intake”) in comparison with the recommended nutritional information of a purchase (i.e., “recommendation”).

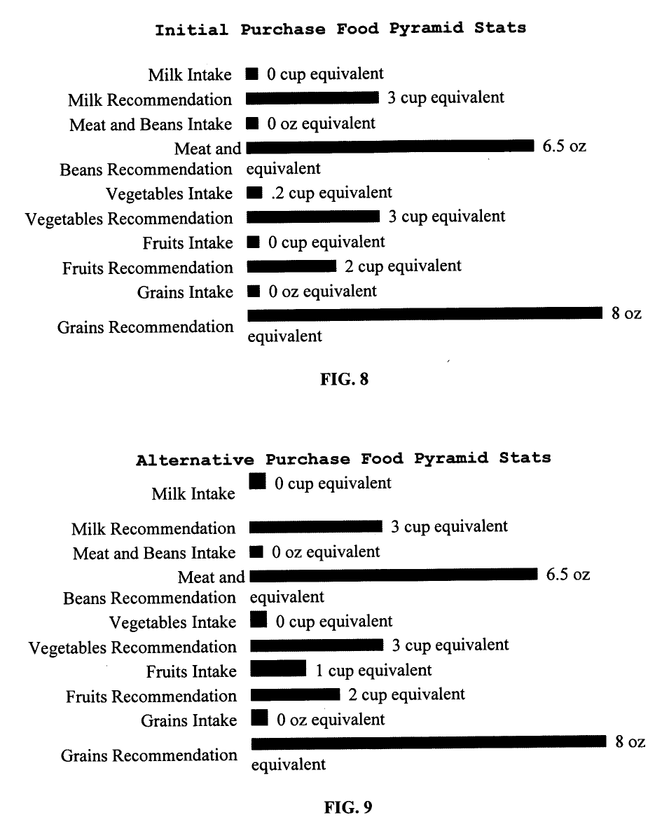

In step 550 server 504 preferably determines that the selected food item(s) is deficient in variety, most food groups and abundant in bad fat. Thus, server 504 preferably communicates alternative food item(s) in such deficient food groups, which are available for purchase, including but not limited to fruit, such as an apple or orange, vegetables, such as carrots, a whole grain snack, a snack with dark chocolate and/or nuts, water or communicates any other food item(s) that fulfill a deficient food group or improves dietary composition of the purchaser's food item(s) selected for purchase. Such alternative food item(s) represent food item(s) having variety, grains, vegetables, fruits, water and/or healthy fat. The nutritional information communicated by server 504 to purchaser 502 preferably would look like the information set forth in FIG. 9. The graphical display in FIG. 9 represents the nutritional information of the alternative food item(s) (i.e., 1 medium apple in “fruit intake”) proposed by server 504 in comparison with the recommended nutritional information of a purchase (i.e., “recommendation”).

In step 560, purchaser 502 would be prompted to amend the initial food item(s) selected for purchase.

For another alternative example, if a purchaser 502 makes a trip to the grocery store and selects the food items listed in Table 1 the identification information communicated by purchaser 502 to server 504 in step 530 preferably would look like the information set forth in Table 1 below.

TABLE 1

| Food Item | Quantity | |
|---|---|---|
| Milk | 1 | gallon |
| Ice Cream | ½ | gallon |
| Cereal | 1 | box |
| Pizza with meat | 2 | large |
| Potato Chips | 1 | bag |
| Cola | 12 | pack 12 oz. cans |
| Beer | 12 | pack 12 oz. cans |

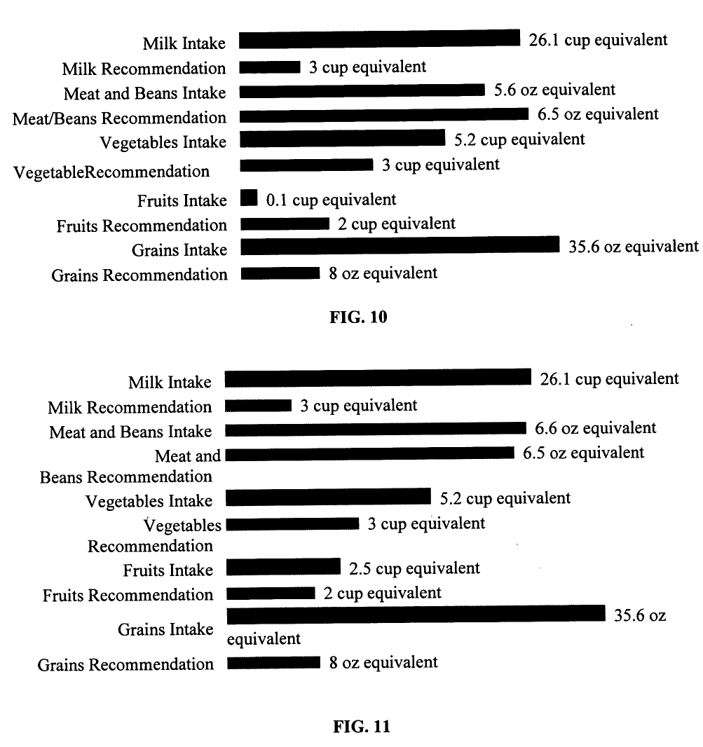

The nutritional information communicated by server 504 in step 540 to purchaser 502 preferably would include the information set forth in FIG. 10. The graphical display in FIG. 10 represents the nutritional information of the food item(s) selected for purchase by purchaser 502 (i.e., “intake”) in comparison with the recommended nutritional information of a purchase (i.e., “recommendation”).

In step 550, server 504 preferably determines that the selected food item(s) are deficient in variety, fruit, meat/bean food groups and abundant in bad fat. Thus, server 504 preferably communicates alternative food item(s) in such deficient food groups, which are available for purchase, including but not limited to fruits such as apples, oranges, and/or a can of beans or communicates any other food item(s) that fulfill a deficient food group or improves dietary composition of the purchaser's food item(s) selected for purchase. The nutritional information communicated by server 504 to purchaser 502 preferably would look like the information set forth in FIG. 11. The graphical display in FIG. 11 represents the nutritional information of the alternative food item(s) (i.e., 2 large apples in “fruit intake” and one (1) can of pinto beans in ”meat and bean intake”) proposed by server 504 in comparison with the recommended nutritional information of a purchase (i.e., “recommendation”).

In step 560, purchaser 502 would be prompted to amend the initial food item(s) selected for purchase.

Although the description given above includes specific examples of currently envisioned embodiments of the computer program, method, system, and/or apparatus, these possibilities should not be understood as limiting the scope of the present version of the invention but rather as providing illustrations of some of the embodiments that are now preferred. Several examples of alternate embodiments are also described and various other alternatives, adaptations, and modifications may be made within the scope of the present version of the invention. Merely listing or numbering the steps or blocks of a method in a certain order does not constitute any limitation on the order of the steps of that method. Many modifications and other embodiments of the invention will come to mind to one skilled in the art to which this invention pertains having the benefit of the teachings presented in the foregoing descriptions and the associated drawings. Although specific terms may be employed herein, they are used in a generic and descriptive sense only and not for purposes of limitation. Accordingly, the claims that follow herein and their legal equivalents, rather than the examples given in the specification, should determine the scope of present version of the invention.

What is claimed is:

1. A nutritional feedback method operational at a point of sale, the nutritional feedback method comprising:
identifying a food item selected for purchase; and
communicating the nutritional information of said food item.

2. The nutritional feedback method of claim 1, further comprising:
identifying an alternative food item based on nutritional information of said identified food item.

3. The nutritional feedback method of claim 2, further comprising:
communicating the nutritional information of said alternative food item.

4. The nutritional feedback method of claim 1, further comprising:
identifying a purchaser of said food item.

5. The nutritional feedback method of claim 4, further comprising:
communicating a prior food item purchased by said purchaser.

6. The nutritional feedback method of claim 4, further comprising:
communicating the nutritional information of said prior food item purchased by said purchaser.

7. The nutritional feedback method of claim 4, further comprising:
querying said purchaser to amend said food item selected for purchase with said alternative food item.

8. The nutritional feedback method of claim 4, further comprising:
storing transaction information of said purchase.

9. The nutritional feedback method of claim 4, further comprising:
communicating the nutritional information of said purchase to said purchaser.

10. The nutritional feedback method of claim 8, further comprising:
communicating transaction information of said purchase to said purchaser.

11. The nutritional feedback method of claim 2, further identifying an alternative food item comprising:
comparing the food item identified for purchase to the alternative food items based on nutritional information.

12. A nutritional feedback system operational at a point of sale comprising:
means for identifying a food item selected for purchase,
means for retrieving nutritional information of said food item from a database, and
means for communicating the nutritional information of said food item.

13. The nutritional feedback system of claim 12, further comprising:
means for identifying an alternative food item based on nutritional information of said identified food item.

14. The nutritional feedback system of claim 13, further comprising:
means for communicating the nutritional information of said alternative food item.

15. The nutritional feedback system of claim 12, further comprising:
means for identifying a purchaser of said food item.

16. The nutritional feedback system of claim 15, further comprising:
means for communicating a prior food item purchased by said purchaser.

17. The nutritional feedback system of claim 16, further comprising:
means for communicating the nutritional information of said prior food item purchased by said purchaser.

18. The nutritional feedback system of claim 15, further comprising:
means for querying said purchaser to amend said food item selected for purchase with said alternative food item.

19. The nutritional feedback system of claim 15, further comprising:
means for storing transaction information of said purchase.

20. The nutritional feedback system of claim 15, further comprising:
means for communicating the nutritional information of said purchase.

21. The nutritional feedback system of claim 19, further comprising:
means for communicating transaction information of said purchase to said purchaser.

22. The nutritional feedback system of claim 13, further comprising:
means for comparing a food item identified for purchase to an alternative food item based on said nutritional information.

23. A computer program comprising a combination of code segments stored in a computer-readable memory and executable by a processor to provide nutrition information related to food items, the computer program comprising:
a code segment operable to receive and store an input related to identifying a food item, and to associate the input with a nutritional record; and
a code segment operable to generate an output to an interactive display screen, wherein the interactive display screen displays the nutritional record of said food item.

24. The computer program as set forth in claim 23, further comprising a code segment operable to sum the nutritional information of food items.

25. The computer program as set forth in claim 23, further comprising a code segment operable to generate an alternative food item based on nutritional information of said identified food item.

26. The computer program as set forth in claim 25, further comprising a code segment operable to compare the identified food item to the alternative food items based on nutritional information.

27. The computer program as set forth in claim 25, further comprising a code segment operable to query a purchaser to amend said identified food item with said alternative food item based on nutritional information.

28. A nutritional feedback system operational on a server, the server providing communication between the server and a purchaser, the nutritional feedback system comprising:
a database in communication with the server, the database comprising dietary components of a plurality of food items;
a display screen in communication with the server, the display screen communicating the nutritional information of said food items to said purchaser.

29. The nutritional feedback system of claim 28, further comprising:
means for identifying the food item selected by purchaser.

30. The nutritional feedback system of claim 28, further comprising:
an alternative food item suggestion program for generating suggested modifications of the purchaser's food items to improve a dietary composition of the food items based upon the recommended dietary information stored within the database.

31. The nutritional feedback system of claim 28, further comprising:
means for summing the nutritional information of the food items.

32. The nutritional feedback system of claim 28, further comprising:
means for communicating the nutritional information of the food items to the purchaser.
